(19) United States
(12) Patent Application Publication
(10) Pub. No.: US 2007/0198666 A1
(43) Pub. Date: Aug. 23, 2007

(54) Systems and methods for configuration management

(75) Inventors: Jeffrey Michael Hoyes, Washington, IL (US); Jonathan Todd Rose, East Peoria, IL (US); Mary Jill Trumper, Sullivan, IL (US); Michael Ray Stephenson, Decatur, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/474,397

(22) Filed: Jun. 26, 2006

Related U.S. Application Data
(60) Provisional application No. 60/774,323, filed on Feb. 17, 2006.

(51) Int. Cl. G06F 15/177

(52) U.S. Cl. 709/220

(57) ABSTRACT

Methods and systems for configuration data management are disclosed. In one embodiment, a configuration management system may be configured to store a product operational control file for controlling a product based on configuration data. The configuration management system may define a plurality of orderable items and relationships between the orderable items and the configuration data. The configuration management system may receive an order for the product including a configuration requirement. The configuration requirement may include one or more of the orderable items. The configuration management system may then load the product operational control file and the configuration data onto the ordered product according to the defined relationship between the orderable item and the configuration data, and the configuration requirement of the ordered product.

### TECHNICAL FIELD

This disclosure relates to systems and methods for configuration data management. More particularly, this disclosure relates to methods and systems for defining, managing, ordering, and loading configuration data for electronic control modules.

### BACKGROUND

Machine control functions continue to evolve from traditional mechanical and analog controls to electronics or microprocessor-based systems. For example, the operation of a machine's engine is generally controlled by a microprocessor-based engine electronic control module (“ECM”), which monitors a variety of input signals and generates output signals to control various components of the engine. The engine ECM can be configured to receive signals from various sensors located at the engine and drive train that are indicative of engine speed, fuel flow, air flow, intake pressure, throttle position, engine temperature, and the like. The engine ECM utilizes the sensor information to calculate various engine-operating parameters that are utilized to generate the output signals, which are provided as operational instructions to the engine components.

In addition to the sensor information, the ECM typically uses a collection of configuration data to customize an engine ECM for a specific configuration. For example, a manufacturer may customize an ECM with numerous variations of configuration data, such as engine size, machine dimensions, engine displacement, optional equipment, load factors, communication protocols, target market, and sensor types and positioning. The numerous variations result in a large number of configuration data sets that must be generated, selected and downloaded to the ECM for supporting a desired operation of the ECM.

Different ECMs are manufactured to provide the specific ECM configuration for each different machine configuration. For example, an ECM with a specific configuration data setting is produced for each of the different machine configurations and stored at the machine assembly plant. Alternatively, an ECM is provided without specific settings, and the specific settings are downloaded to the ECM during the assembly process.

These techniques, however, affect certain aspects of the manufacturing process. For example, producing an ECM with a specific configuration data set for each of the various engine or machine configurations results in a significant inventory of ECMs to support the assembly of a machine that has numerous engine or other configurations.

One approach of managing the configuration management process focuses on methods to configure a machine ECM while minimizing inventory requirements and reducing the total production time. For example, U.S. Pat. No. 6,529,805 to Aldrich, III, et al. discloses a method and apparatus for configuring an ECM for multiple automobile configurations. The disclosed apparatus includes an automobile identifier identifying one of the multiple automobile configurations, and a memory configured to store multiple configuration data sets, with each of the multiple data sets corresponding to one of the multiple configurations. The apparatus also includes a processor configured to receive the automobile identifier and select one of multiple data sets based at least in part upon the automobile identifier for execution of automobile functions controlled by the automobile ECM.

Another way to manage configuration data is to establish a verification mechanism after a customer submits an order for a desired configuration. For example, U.S. Pat. No. 7,003,548 to Barck et al. discloses a method for developing a technical configuration and electronically delivering an order report for the technical configuration. The method includes interactively eliciting and electronically receiving from a client a desired technical configuration. The method provides, from the server to the client, a limited configuration engine. The limited configuration engine may be used to perform a first, limited check on the viability of the desired technical configuration on the client. The method further includes performing a second, final check on the viability of the desired technical configuration using a full configuration engine on the server. In response to the final check, the server would prepare and output on the client an electronic order report.

While conventional methods may be effective for managing configuration data for ECMs for ordered products, they do not fully integrate the configuration management process in the design, manufacturing, and sales/delivery phases of a product. Therefore, methods and systems consistent with certain disclosed embodiments address one or more of these problems.

### SUMMARY OF THE INVENTION

It is to be understood that both the foregoing general description and the following detailed description are exemplary and explanatory only and are not restrictive of the invention as claimed.

Methods and systems for configuration data management are disclosed. In one embodiment, a configuration management system may be configured to store a product operational control file for controlling a product based on configuration data. The configuration management system may define a plurality of orderable items and relationships between the orderable items and the configuration data. The configuration management system may receive an order for the product including a configuration requirement. The configuration requirement may include one or more of the orderable items. The configuration management system may then load the product operational control file and the configuration data onto the ordered product according to the defined relationship between the orderable item and the configuration data, and the configuration requirement of the ordered product.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1A is a block diagram of a configuration management environment consistent with certain disclosed embodiments;

FIG. 1B is a block diagram of data for a part and two devices consistent with certain disclosed embodiments;

FIG. 2 is a block diagram of a configuration management architecture consistent with certain disclosed embodiments;

FIG. 3A is a flow chart illustrating a process to define and release product operational control and configuration data file definition files consistent with certain disclosed embodiments;

FIG. 3B is a configuration data file definition file consistent with certain disclosed embodiments of the present disclosure;

FIG. 4A is a flow chart illustrating a process to define a relationship between an orderable item and configuration data consistent with certain disclosed embodiments;

FIG. 4B is a block diagram of a relationship between an orderable item and configuration data consistent with certain disclosed embodiments;

FIG. 5 is a flow chart illustrating a detailed process to define a relationship between an orderable item and configuration data consistent with certain disclosed embodiments;

FIG. 6A is a flow chart illustrating a process to order a product and load configuration data for the ordered product consistent with certain disclosed embodiments; and

FIG. 6B is a block diagram of a product build order file consistent with certain disclosed embodiments.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

Methods and systems consistent with the disclosed embodiments may relate to a configuration data management system for ECMs for use in a product. A product may be any type of machine or service that utilizes one or more ECMs to control one or more components. A product may be a machine, such as a backhoe loader, a skid steer, an excavator, a tractor, a truck, a vehicle, or any other machine known in the art. Although a machine is used to describe certain disclosed embodiments, these and other embodiments may be applied to other products which require configuration data management processes.

An ECM may be a processing device, software, an embedded computer system, and the like, that controls one or more of the components in a product, such as pumps, control inputs, HVAC, transmissions, braking systems, steering systems, engines, and various other tools and actuation systems known in the art. For example, an engine ECM may be used with an internal combustion engine to collect data from one or more sensors in the engine and use the information to control the engine. The use of an engine ECM permits the engine's operation to be controlled in great detail to obtain greater fuel efficiency, improved power and responsiveness, and better pollution control. An ECM may use a product operational control file to perform its functions.

The product operational control file may be any type of file whose content may be interpreted by a program in an ECM, a component of a product, or a product. The product operational control file may access configuration data from an ECM's memory device. An ECM may store configuration data in a memory device, such as a flash memory or an erasable programmable reading only memory (EPROM). An ECM's memory device may contain configuration data reflecting part information, communication protocols supported by the ECM, and other configuration data settings supported by a product.

Configuration data refers to information represented in a form suitable for processing by an ECM to control one or more components in a product. A configuration parameter refers to a piece of configuration data that needs to be assigned a specific value for the operations of a component and/or a product.

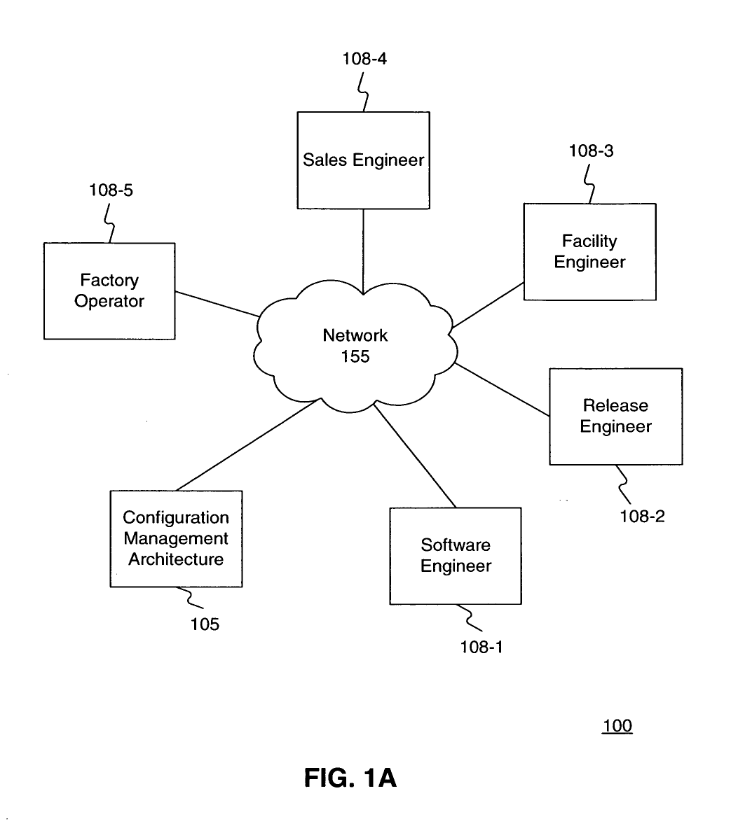

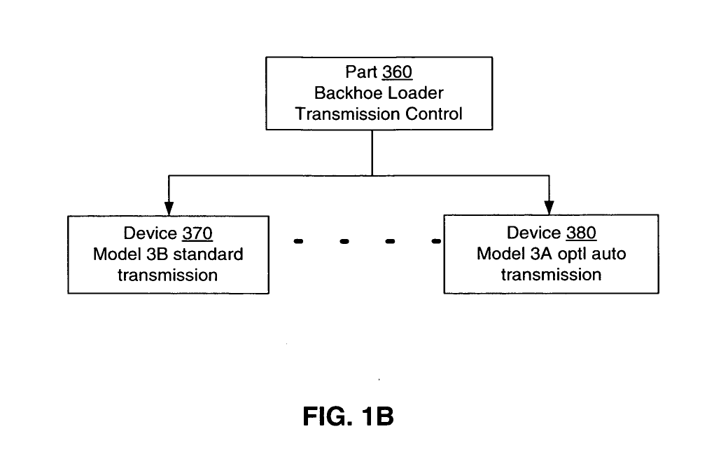

FIG. 1A illustrates an exemplary configuration management environment 100 consistent with certain embodiments of the present disclosure. As shown in FIG. 1A, configuration management environment 100 may include a configuration management architecture 105, a software engineer 108-1, a release engineer 108-2, a facility engineer 108-3, a sales engineer 108-4, a factory operator 108-5 and a network 155.

Configuration management architecture 105 may be a computer system including hardware/software that enables collaboration among the members 108 (for example, software engineer 108-1, release engineer 108-2, facility engineer 108-3, sales engineer 108-4, and factory operator 108-5) in configuration management environment 100. A member may be any individual, software application, and/or system within configuration management environment 100. Configuration management architecture 105 may also generate, maintain, update, delete, and present configuration data records, such as configuration data for certain machine parts, and configuration data change entries. A configuration data record may include data related to the definition and processes of a component for a product, or a part of a product, in configuration management architecture 105.

Software engineer 108-1, release engineer 108-2, facility engineer 108-3, sales engineer 108-4, and factory operator 108-5 may each reflect one or more individuals who perform corresponding configuration management functions in configuration management environment 100. Software engineer 108-1, release engineer 108-2, facility engineer 108-3, sales engineer 108-4, and factory operator 108-5 may also represent computer systems or software applications executed by processors configured to perform their corresponding functions in configuration management environment 100. These computer systems may each include a memory, a processor, and a display for presenting one or more maps, graphs, messages, and the like, consistent with certain disclosed embodiments of configuration management architecture 105. In one embodiment, software engineer 108-1 may interact with release engineer 108-2, facility engineer 108-3, sales engineer 108-4, and factory operator 108-5 via network 155. Network 155 may be the Internet, a wireless local area network (LAN), or any other type of network. Thus, network 155 may be any type of communications system. For example, each member may provide inquiries or respond to inquiries using network 155.

In one embodiment, software engineer 108-1 may define and access configuration data records or change entries via configuration management architecture 105. Software engineer 108-1 may determine which configuration parameters are supported for a product, and the values for the configuration parameters. Software engineer 108-1 may also identify the sequence that the configuration parameters are loaded on an ECM. Alternatively, configuration management architecture 105 may determine the sequence that the parameters are loaded on an ECM. Software engineer 108-1 may interact with configuration management environment 100 using a computer system, work stations, or other type of computing device connected to network 155.

A part may reflect one or more software or hardware components of a product. A part may be a product operational control file which accesses configuration data of a control module. A part may include multiple devices. A device may be a component of a part or a type of a part. FIG. 1B is a block diagram of a relationship between a part and two devices. For example, a flash file part 360 may include two devices: 370 and 380. Part 360 may be a software component which accesses the configuration data for a control module in a machine, such as a backhoe loader transmission control module. Flash file part 360 may be used to access configuration data for control modules of two types (i.e., models) of backhoe loaders: device 370 (transmission control module for sales model 3B), and device 380 (the transmission control module for sales model 3A). That is, flash file part 360 may be used to access configuration data for ECMs of either device.

Software engineer 108-1 may be an individual who develops software during the design phase of a product. Software engineer 108-1 may create product operational control files and configuration data file definition files for new products and new product parts. A product operational control file may be any type of executable file known in the art, such as a flash file. For example, in the design phase for a product, software engineer 108-1 may create one or more flash files that uses configuration data to control the operation of the product.

Software engineer 108-1 may also create configuration data file definition files, such as a configuration data file definition file (FDF), to specify the valid settings for configuration data of each ECM. In one embodiment, software engineer 108-1 may create a flash file to load configuration data for backhoe loader transmission ECMs. Software engineer 108-1 may design a flash file that supports more than one device (for example, two sales models 3A and 3B of the backhoe loader). Software engineer 108-1 may then create an FDF file, which defines all possible settings for the configuration data to be loaded by the flash file. That is, the configuration data file definition file documents all supported features for the two devices, such as all possible transmission types for sales models 3A and 3B (a manual transmission or an automatic transmission). Software engineer 108-1 may also identify one or more communication protocols used for loading configuration data into the ECMs. Because different products and ECMs may require different protocols, incorrectly specified communication protocol or device identification in the flash file may cause delays in a downstream manufacturing process for the machine. Although only one software engineer 108-1 is illustrated in FIG. 1A, configuration management environment 100 may include a plurality of software engineers who collectively or individually perform similar tasks.

Release engineer 108-2 may be an individual who has the authority to review the product operational control files and/or configuration data file definition files submitted by software engineer 108-1. Release engineer 108-2 may release files generated by software engineer 108-1 to facility engineer 108-3, sales engineer 108-4, and factory operator 108-5 when a new part or a new product is ready to be manufactured. Referring to the previous example, when the backhoe loader is ready to be manufactured at manufacturing facilities, through configuration management architecture 105, release engineer 108-2 may authorize the access to the flash files and data file definition files created by software engineer 108-1 to facility engineer 108-3, sales engineer 108-4, and factory operator 108-5. Release engineer 108-2 may authorize limited access to the files to certain manufacturing facilities, or only to certain members 108 of configuration management environment 100. Although only one release engineer 108-2 is illustrated in FIG. 1A, configuration management environment 100 may include a plurality of release engineers who perform similar tasks.

Facility engineer 108-3 may be an individual who defines configurations of parts and products manufactured in one or more manufacturing sites. A manufacturing site may be the location of any facility that manufactures one or more parts for one or more products. Facility engineer 108-3 may define orderable items for a product. An orderable item may be identified by its item identification number. An orderable item refers to any software or hardware component that may be ordered/selected by a customer when purchasing a product. For example, when purchasing a machine, a customer may select an engine model (for example, 4-cylinder or 6-cylinder) for the machine. Thus, the engine may be an orderable item. Configuration data settings for the selected engine's ECM may also be an orderable item.

Facility engineer 108-3 may also define orderable item variables. An orderable item variable refers to a piece of data that needs to be specified for an orderable item. Each orderable item may require one or more orderable item variables. For example, engine speed may be an orderable item variable. Facility engineer 108-3 may configure various engine speeds (orderable item variable values), such as idle engine speed or maximum engine speed, for the orderable item (engine). Referring to the backhoe loader example, facility engineer 108-3 may define a transmission as an orderable item for a backhoe loader. Facility engineer 108-3 may then define the orderable item variables related to the transmission. One orderable item variable may be the sales model of the backhoe loader that determines the type of transmission of the machine. For example, a backhoe loader of sales model 3A may only be designed and/or ordered with one type of transmission (automatic transmission).

Furthermore, facility engineer 108-3 may specify relationships between an orderable item and its corresponding configuration data. Such relationships may be defined as logic associations between orderable items to their configuration data. The relationship may include a qualifying condition and a set of configuration data. Referring back to the backhoe loader example, facility engineer 108-3 may further define the relationship between an orderable item (transmission) and the configuration data for the transmission. For instance, facility engineer 108-3 may define the following orderable item to configuration data relationship (“ITC relationship”):
if the ordered item is the transmission, and the sales model is 3A (qualifying condition), then set the transmission type (configuration data) to automatic.

Facility engineer 108-3 may store the ITC relationship in configuration management architecture 105. Facility engineer 108-3 may also verify the validity of the ITC relationship by checking the FDF file defined by software engineer 108-1. The FDF file documents all possible settings for configuration data related to the corresponding part. Thus, if a configuration data setting in an ITC relationship is not included in the valid settings defined in the corresponding FDF file, configuration management architecture 105 may flag the ITC relationship as an invalid relationship. Although only one facility engineer 108-3 is illustrated in FIG. 1A, configuration management environment 100 may include a plurality of facility engineers who perform similar tasks.

Sales engineer 108-4 may be an individual who receives sales orders from a customer, and creates a product build order (“PBO”) file according to the received sales orders. A PBO file may be a computer-based file that includes the data required to properly schedule and assemble the ECMs on the ordered product. In one embodiment, a PBO file may be an eXtensible Markup Language (“XML”) file. Referring back to the backhoe loader example, sales engineer 108-4 may receive a purchase order from a customer for a Model 3A backhoe loader. Sales engineer 108-4 may create a PBO file to define data required to properly schedule and assemble the ECMs of the ordered backhoe loader. For example, sales engineer 108-4 may specify in the PBO that a transmission ECM needs to be configured for the ordered item “transmission,” the sales model for the ordered product is 3A, and/or the engine ECM needs to be configured before the transmission ECM is configured. Sales engineer 108-4 may submit PBO files to configuration management architecture 105.

Sales engineer 108-4 may verify that a PBO file specifies a proper build and assemble schedule for ECMs on the ordered product by checking configuration data records stored in configuration management architecture 105. Sales engineer 108-4 may use the configuration management architecture 105 to search for ITC relationships defined for ordered item “transmission” for backhoe loaders of sales model 3A. Configuration management architecture 105 may retrieve the ITC relationship defined by facility engineer 108-3 (i.e., if the ordered item is the transmission, and the sales model is 3A, then the transmission type would be set to automatic). Configuration management architecture 105 may compare data from the PBO (ordered item “transmission,” sales model 3A) to the qualification condition of the ITC relationship (the ordered item is “transmission,” and the sales model is 3A). Because the PBO data satisfy the ITC relationship's qualification condition, configuration management architecture 105 may provide the configuration data defined in the ITC relationship, “transmission type” with the value set to “automatic,” to factory operator 108-5. Although only one sales engineer 108-4 is illustrated in FIG. 1A, configuration management environment 100 may include a plurality of sales engineers who perform similar tasks.

Factory operator 108-5 may be an individual who loads a product operational control file and configuration data into an ordered product, such as an ECM of a machine. Factory operator 108-5 may load the configuration data according to the information in the PBO file for the ordered product. Factory operator 108-5 may verify through configuration management architecture 105 the configuration data loaded on the ECM and required by the PBO. Configuration management architecture 105 may check the PBO submitted by sales engineer 108-4 against the ITC relationships defined by facility engineer 108-3, and then compare the correct configuration data required by the PBO against the configuration data loaded on the ECM.

Referring back to the backhoe loader example, factory operator 108-5 may use configuration management architecture 105 to load configuration data onto the ordered backhoe loader with a sales model of 3A, as specified in the PBO. Factory operator 108-5 may then use configuration management architecture 105 to load the flash file generated by software engineer 108-1 onto the transmission ECM. Factory operator 108-5 may use the configuration management architecture 105 to verify that the correct configuration data settings were loaded onto the ECM. Although only one factory operator 108-5 is illustrated in FIG. 1A, configuration management environment 100 may include a plurality of factory operators who perform similar tasks.

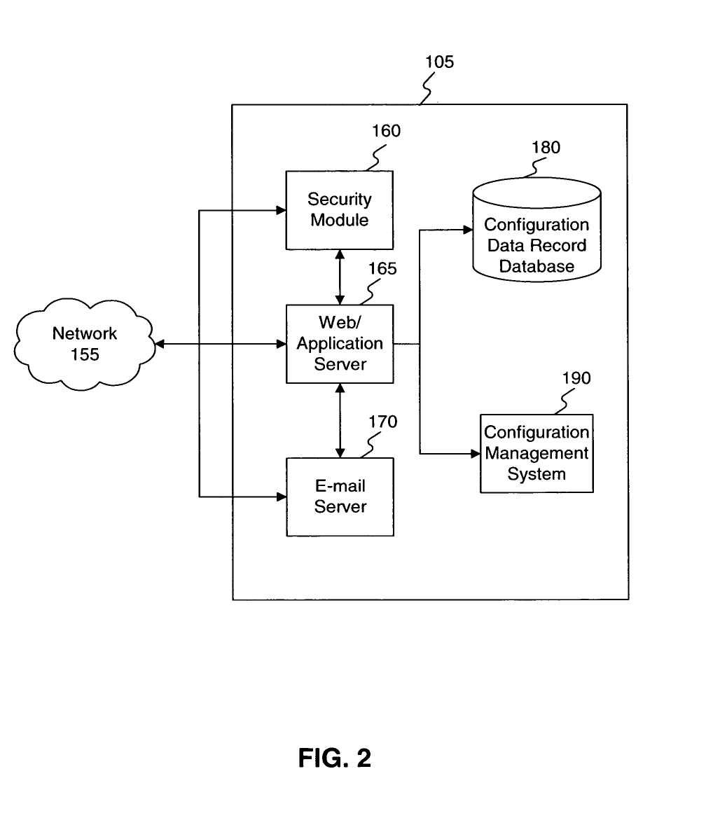

FIG. 2 is a block diagram illustrating a configuration management architecture 105. Configuration management architecture 105 may include a security module 160, a Web/application server 165, an e-mail server 170, a configuration data record database 180, and a configuration management system 190. Security module 160, Web/application server 165, and e-mail server 170 interface with network 155. Web/application server 165 may also be connected to security module 160, e-mail server 170, configuration data record database 180, and configuration management system 190. It is contemplated that a configuration management architecture 105 may include additional or fewer components than those shown in FIG. 2.

Security module 160 may be a computer system or software executed by a processor that is configured to determine what type of access each member in configuration management environment 100 has with respect to configuration data record database 180 and/or configuration management system 190. For example, factory operator 108-5 may be authorized to access records in configuration data record database 180 but not authorized to modify the records. Software engineer 108-1 and/or facility engineer 108-2, on the other hand, may be permitted to access and modify data store in configuration data record database 180. Further, security module 160 may be used to assign and verify different levels of access for different members, based on, for example, a member's role in configuration management environment 100. For example, facility engineer 108-3 may be permitted access to only a portion of configuration data record database 180 related to a manufacturing facility associated with facility engineer 108-3. Software engineer 108-1, however, may be allowed to access data stored in the entire configuration data record database 180.

Web/application server 165 may include an interface that allows members 108 to access and edit configuration data record database 180, and/or configuration management system 190. Further, web/application server 165 may generate a notification, such as an email, that is sent to one or more members 108 of configuration management environment 100. The notification may indicate that the configuration management architecture 105 has completed an operation or a record has been received. The notification may also indicate that the operation or record is available for review.

Web/application server 165 may also include additional components, such as collaboration tools to permit collaboration of members 108 of configuration management environment 100, bulletin boards to permit individuals of configuration management environment 100 to communicate with each other, and/or search engines to provide efficient access to specific entries in configuration data record database 180 or configuration management system 190. In one embodiment, web/application server 165 may be Apache HTTP Server from the Apache Software Foundation, IBM WebSphere, or any other web/application server known in the art.

E-mail server 170 may be a computer system or software executed by a processor that is configured to provide e-mail services for members of configuration management environment 100. The e-mail services may provide messages including current information from configuration management architecture 105. For example, when a new part including configuration data for a new product is available to be released to manufacturing facilities, configuration management system 190 may use e-mail server 170 to send the product's production dates to members in the configuration management environment 100. Alternatively, software engineer 108-1, release engineer 108-2, facility engineer 108-3, sales engineer 108-4, and/or factory operator 108-5 may use e-mail server 170 to send notices to other members of configuration management environment 100 of a newly released product with related configuration data files accessible through web/application server 165.

Configuration data record database 180 may be a database computer system and/or software executed by a processor that is configured to store data records, entries for changes made to the data records, and other information used by individuals in configuration management environment 100. Configuration management architecture 105 may include one or more configuration data record databases.

In one embodiment, configuration data record database 180 may store configuration data records and configuration data files. A configuration data record may include configuration information for a product and/or a product part, such as part number, part name, product family, product type, and the like. A Configuration data file for a product part, such as an engine, may include one or more configuration data records providing configuration data for the part. Configuration data record database 180 may store orderable items and their related orderable item variables for available products. Configuration data record database 180 may store ITC relationships defined by facility engineer 108-3. Configuration data record database 180 may also store PBO files for ordered products, and one or more build schedules for ordered products. A build schedule includes information regarding the steps, timing, configuration data settings, and the like, used to configure an ordered product.

Configuration management system 190 may be a computer system or software executed by a processor that is configured to provide access to records stored in a number of different formats, such as word processing format, spread sheet format, presentation format, and the like. Configuration management system 190 may also permit the capture of configuration data creations and changes, by hosting a management process that facilitates the activities of members 108 of configuration management environment 100. Configuration management system 190 may enable members of configuration management environment 100 to define configuration data based on product options ordered by a customer.

In one embodiment, configuration management system 190 may allow facility engineer 108-3 to define ITC relationships as associations between orderable items and the configuration data. Configuration management system 190 may save the ITC relationships in configuration data record database 180. Sales engineer 108-4 may submit PBO files for ordered products with their respective requested configurations. Configuration management system 190 may check a PBO against saved ITC relationships to determine the configuration data values to be loaded in the ECMs of the ordered product. Configuration management system 190 may determine the sequence for multiple configuration parameters to be loaded onto an ECM (for example, the sequence may be based on technical and/or functional dependencies among the configuration parameters).

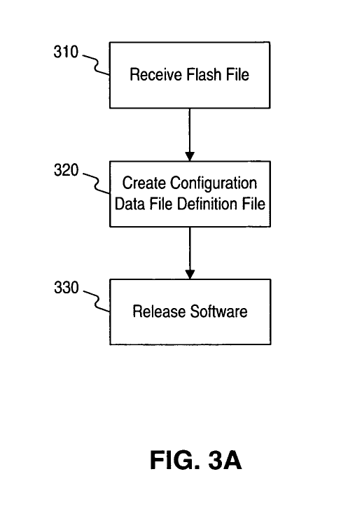

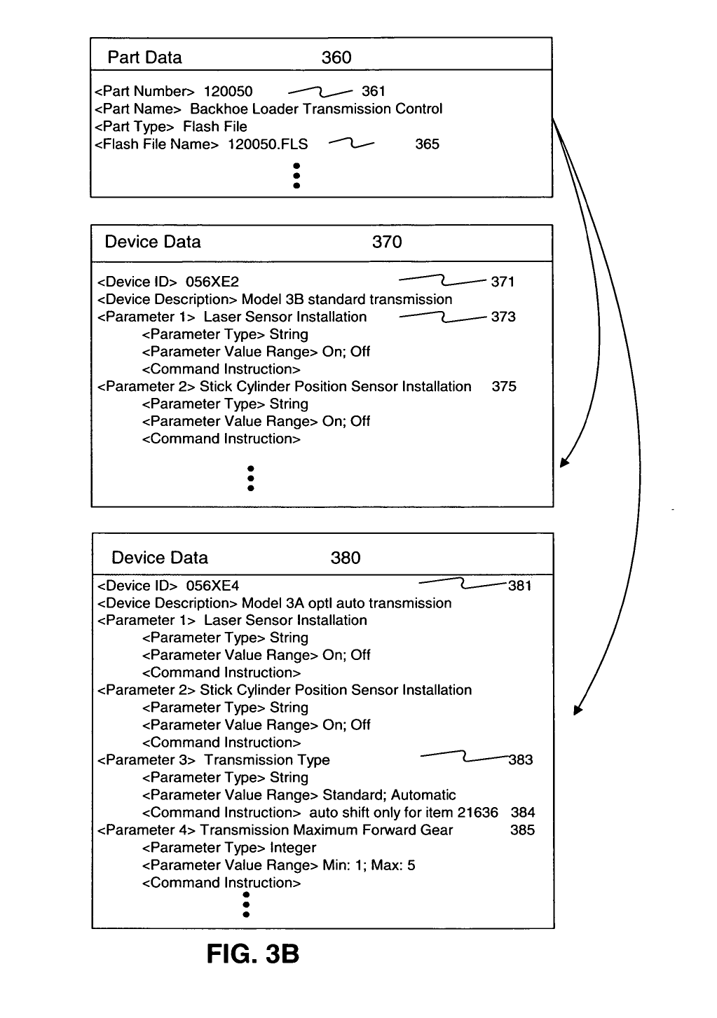

FIG. 3A illustrates a flow chart of a process for creating a configuration data file definition file (FDF) consistent with certain disclosed embodiments. First, software engineer 108-1 may use configuration management system 190 to receive a product operational control file that is used to operate an ECM and access configuration data in an ECM (step 310). Configuration management system 190 may load a product operational control file and configuration data into a target ECM. Software engineer 108-1 may assign the product operational control file a part number that refers to the hardware component of a product the product operational control file supports. Software engineer 108-1 may also define one or more device identification numbers supported by the product operational control file. A device identification number may uniquely identify a target ECM in a product. The product operational control file may be stored in configuration data record database 180 or another data repository not shown in FIG. 2.

For example, software engineer 108-1 may receive a flash file for a part for a backhoe loader. The selected part may be the backhoe loader transmission control having a part number of 120050. Software engineer 108-1 may name the flash file 120050.FLS, with the file name referring to the part number. Software engineer 108-1 may also specify one or more devices supported by this flash file. In this example, two identification numbers may be specified as being supported by this flash file: device number 056XE2 for sales model 3B, and device number 056XE4 for sales model 3A. Thus, the two device identification numbers included in the flash file indicate that flash file 120050.FLS may be used to access configuration data in either the ECM for transmission control of sales model 3B or the ECM for transmission control of sales model 3A.

Software engineer 108-1 may also define a configuration data file definition file (FDF) that contains the supported features for a product part (step 320). The configuration data file definition file may include the part number, device identification numbers, and other configuration data supported in the file. One configuration data file may be created for each supported product operational control file (for example, a flash file). Alternatively, if multiple product operational control files refer to a common set of configuration data, a single configuration data file definition file may be used to provide configuration data settings for multiple product operational control files.

FIG. 3B shows a configuration data file definition file (FDF). As shown in FIG. 3B, software engineer 108-1 may create a configuration data file definition file that includes part data 360, and device data 370 and 380. Software engineer 108-1 may specify that the configuration data file definition file is to support part number 361, 120050 (i.e., the backhoe loader transmission control), and name this configuration data file definition file 120050.FDF. Software engineer 108-1 may also specify that flash file 365 (120050.FLS) is supported by this FDF file. Further, software engineer 108-1 may specify that device number 371, 056XE2 (i.e., sales model 3B), and device number 382, 056XE4 (i.e., sales model 3A), are supported by this configuration data file definition file. Software engineer 108-1 may further specify one or more possible settings for the configuration data associated with the two devices.

For example, software engineer 108-1 may define configuration parameter 373 (laser sensor installation) of device 056XE2 (the model 3B standard transmission), to one of two values (on or off). And, software engineer 108-1 may also set configuration parameter 375 (stick cylinder position sensor installation) to one of two values (on or off). For device 056XE4 (the model 3A optional automatic transmission), in addition to the two configuration parameters 373 and 375, software engineer 108-1 may define data settings for configuration parameters 383 and 385. For instance, software engineer 108-1 may set configuration parameter 383 (transmission type) to one of two values (standard or automatic). Software engineer 108-1 may also set configuration parameter 385 (transmission maximum forward gear) to a numeric value (an integer value between 1 and 5). Command instruction 384 indicates to release engineer 120, facility engineer 108-3, sales engineers 108-4, and factory operator 108-5 that configuration parameter 383, transmission type, may only be set to automatic if item number 21636 is ordered. The values and types of data described above are exemplary and are not intended to be limiting to the disclosed embodiments.

Release engineer 108-2 may review and approve configuration data file definition files defined by software engineer 108-1. Based on product manufacturing schedules and other relevant information, release engineer 108-2 may provide the product operational control files and configuration data file definition files defined by software engineer 108-1 to facility engineer 108-3, sales engineer 108-4, and/or factory operator 108-5 through configuration management architecture 105 (step 330). For example, when part number 120050 (i.e., the backhoe loader transmission control) is ready to be manufactured, release engineer 108-2 may use configuration management system 190 to authorize facility engineer 108-3, sales engineer 108-4, and factory operator 108-5 to access the product operational control files and configuration data file definition files related to part number 120050, such as flash file 120050.FLS, and configuration data file definition file 120050.FDF. Release engineer 108-2 may also designate which manufacturing facilities are allowed access to which configuration files.

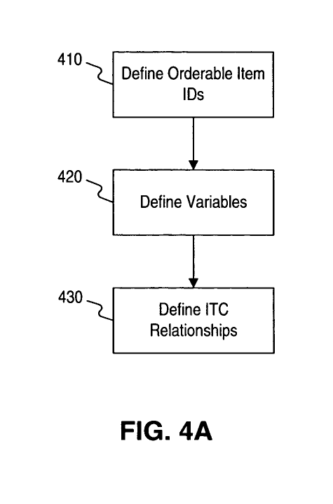

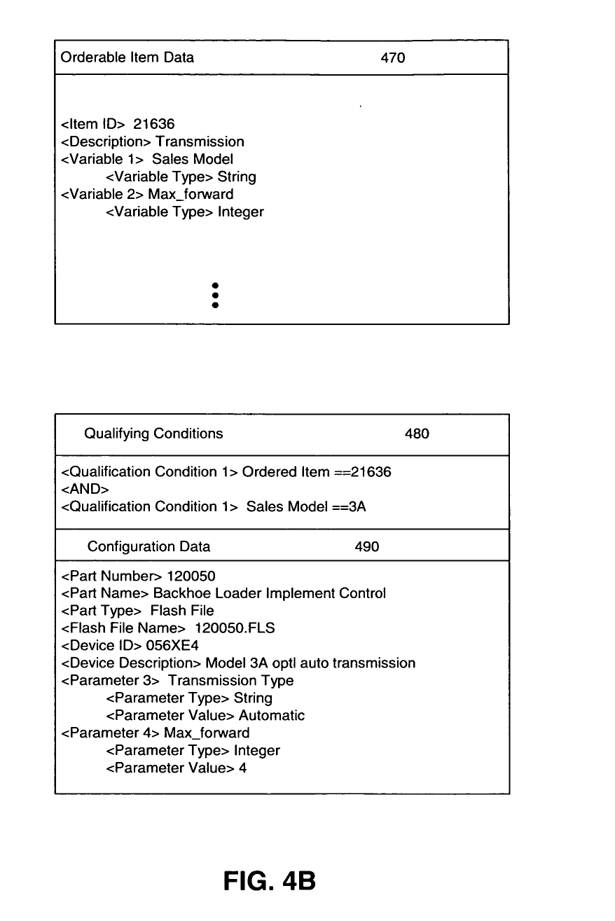

After release engineer 108-2 authorizes other members of configuration management environment 100 to access product operational control files and configuration data file definition files for a product, facility engineer 108-3 may define orderable items for the product and their corresponding configuration data. FIG. 4A illustrates a flow chart of a process for creating a relationship between an orderable item and its corresponding configuration data. Facility engineer 108-3 may first define an orderable item identification in configuration management architecture 105 (step 410). An orderable item refers to any orderable components or features of an ordered product that may determine the setting of configuration data in an ECM. FIG. 4B shows a relationship between an orderable item with mapping to its corresponding configuration data settings. An orderable item may be described by orderable item data (orderable item data 470). For example, facility engineer 108-3 may define an orderable item with an identification number of 21636 by naming a transmission as the item description.

Facility engineer 108-3 may also define one or more orderable item variables that are specific to an orderable item (step 420). An orderable item variable may correspond to a configuration parameter. Referring back to FIG. 4B, facility engineer 108-3 may define for orderable item 21636 (a backhoe loader transmission) two orderable item variables: sales model and max_forward. Facility engineer 108-3 may further define the data formats of each of the orderable item variables, such as a string format, or a number format, and the like. Facility engineer 108-3 may also update or delete any orderable item variables defined for an orderable item.

Next, facility engineer 108-3 may define the relationship between an orderable item and its configuration (“ITC”) data in configuration management architecture 105 (step 430). An ITC relationship may include one or more qualifying conditions 480 that map the orderable item 470 to its proper configuration data settings 490. Sales engineer 108-4 may use an ITC relationship to request configuration data for an ordered product through configuration management architecture 105. Upon receiving a PBO from sales engineer 108-4, configuration management system 190 may filter product specific information submitted in the PBO against the qualifying conditions defined in ITC relationships to determine the configuration data settings for the ordered product.

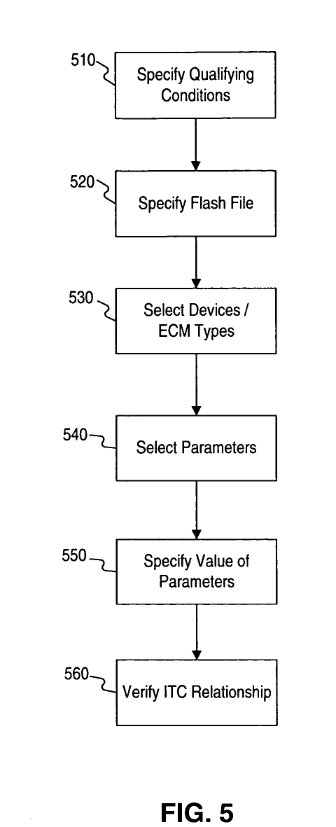

FIG. 5 illustrates a flow chart for a process for defining an ITC relationship. As mentioned earlier, FIG. 4B illustrates a ITC relationship including qualifying conditions 480 that map the orderable item 470 to appropriate configuration data 490. To define the ITC relationship for orderable item 21636, facility engineer 108-3 may first define two conjunctive qualification conditions 480: “sales model=3A” and “orderable item=21636” (step 510).

For the ITC relationship for orderable item 21636, facility engineer 108-3 may also specify a product operational control file that may access configuration data in the ECM of the orderable item (step 520). For example, facility engineer 108-3 may specify that the configuration management system may load the product operational control file 120050.FLS and load configuration data into the ECM for orderable item 21636.

Flash file 120050.FLS may include a list of all devices that can use this flash file to access configuration data. Accordingly, facility engineer 108-3 may then select from the list, devices defined for the selected flash file (step 530). For example, facility engineer 108-3 may select device 381, 056XE4, (sales model 3A optional auto transmission) from devices defined in flash file 120050.FLS for part 120050.

Next, facility engineer 108-3 may select the configuration parameters to configure for the selected device (step 540). Referring back to the example in FIG. 4B, facility engineer 108-3 may choose to configure two configuration parameters for device 056XE4: parameter 3, transmission type, and parameter 4, transmission maximum forward gear. Facility engineer 108-3 may then assign one or more values to the selected configuration parameters (step 550). Referring back to the above example, facility engineer 108-3 may set parameter 3 (transmission type) to “automatic” shift, and parameter 4 (max_forward) to forward gear number 4. Facility engineer 108-3 may save the ITC relationship in configuration data record database 180, and also submit the ITC relationship to configuration management system 190. Facility engineer 108-3 may define the sequence for multiple orderable items to be loaded onto an ordered product based on technical and/or functional dependencies among the orderable items. Alternatively, configuration management system 190 may define the sequence for multiple orderable items to be loaded onto an ordered product based on technical and/or functional dependencies among the orderable items.

Additionally, facility engineer 108-3 may verify the validity of the ITC relationship by checking the corresponding configuration data file definition file, such as 120050.FDF (step 560). The configuration data file definition file documents all possible settings for configuration data related to flash file 120050.FLS.

For example, facility engineer 108-3 may use configuration management system 190 to verify the validity of the ITC relationship shown in FIG. 4B. Because the ITC relationship corresponds to flash file 120050.FLS, facility engineer 108-3 may verify configuration data 490 against configuration data file definition file 120050.FDF (as defined in step 320 and shown in FIG. 3B). Configuration management system 190 may verify that the value set for parameter 3 (transmission type=automatic) in the ITC relationship is among the valid values (manual or automatic) defined for parameter 3 in the configuration data file definition file, and the value set for parameter 4 (max_forward=4) in the ITC relationship is among the valid values (1-5) defined for parameter 4 in the configuration data file definition file. Configuration management system 190 may then conclude and indicate to facility engineer 108-3 that the ITC relationship as shown in FIG. 4B is valid. Alternatively, if applicable, configuration management system 190 may prompt facility engineer 108-3 to correct/redefine an invalid ITC relationship.

After facility engineer 108-3 has defined orderable items and related ITC relationships for a product, sales engineer 108-4 may order the product from configuration management system 190 with configuration requirements. A configuration requirement may be any orderable configuration for one or more components of a ordered product. A configuration requirement may include one or more orderable items.

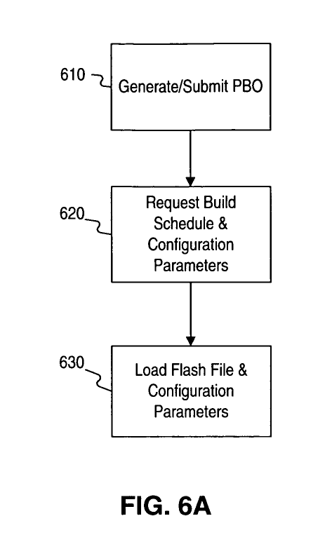

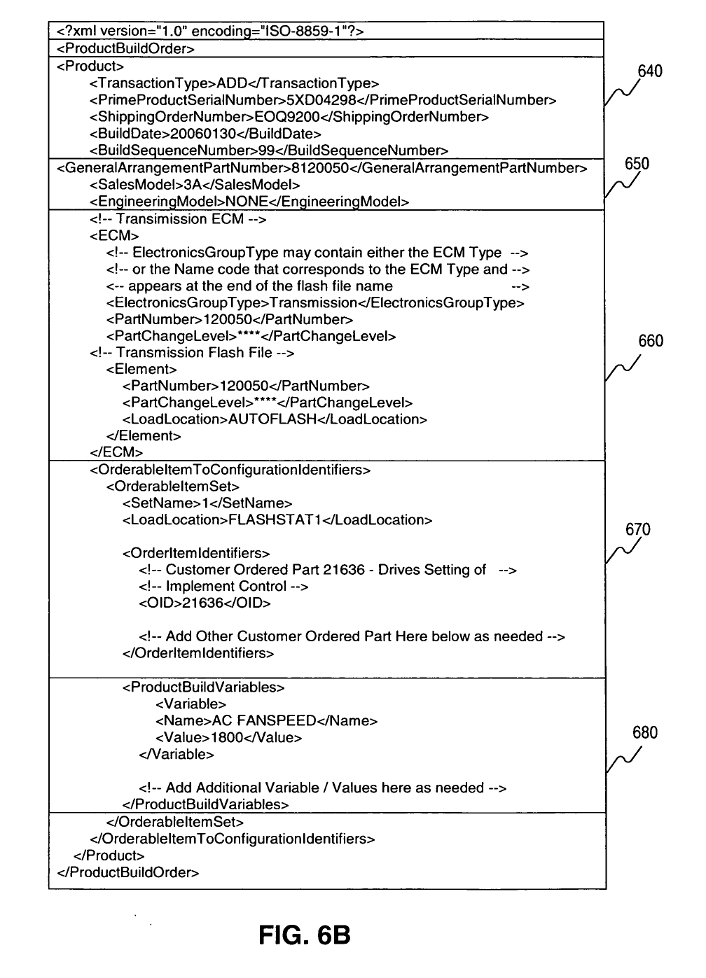

FIG. 6A is a flow chart of a process for submitting a build order for a product and loading the proper configuration data for the product. When a customer orders a product, sales engineer 108-4 may generate a PBO file that contains information specific to the ordered product. Accordingly, sales engineer 108-4 may define and submit the PBO file to configuration management architecture 105 (step 610). A PBO file may be an XML file that includes information defining the sequence of proper build/assembly for an ordered product. Because an ordered product usually includes a numbers of configuration requirements, a PBO file may include data needed for multiple orderable items, such as data settings for orderable item variables. For example, a PBO for a backhoe loader may include an ordered item for a transmission (21636) ECM, an ordered item for an engine ECM, and the like. In one embodiment, sales engineer 108-4 may create a PBO file using tools such as text editors. Alternatively, sales engineer 108-4 may generate a PBO file by using a computer system that can access information in systems such as factory scheduling systems and other planning systems, such as configuration management system 190.

FIG. 6B shows a PBO file in XML format. As shown in FIG. 6B, a first part of the PBO file (640, 650, and 660) may include information describing the ordered product, such as the product serial number (uniquely identifies the ordered product), the engineering model, ECMs, flash files, and the like. A second part (670 and 680) of the PBO file may include the product's orderable items, such as ordered item 21636. The product build variable element 680 in the PBO file may refer to configuration data which can be set by sales engineer 108-4 or other planning systems through the PBO (fan speed for air conditioning of a machine's cabin). Configuration requirement of the ordered product may include 660, 670, and 680. Sales engineer 108-4 may submit PBO files for ordered products to configuration management architecture 105.

Factory operator 108-5 may build the ordered product (a backhoe loader) by requesting a build schedule and the correct configuration data as requested in the PBO file (step 620). When configuration management system 190 receives a request from factory operator 108-5, configuration management system 190 may check the specific ordered items (21636) and other related information (sales model) against the ITC relationships stored in configuration data record database 180 to determine the appropriate configuration data.

For example, in the PBO file shown in FIG. 6B, sales engineer 108-4 specifies item 21636 as being ordered for a sales model 3A backhoe loader with a serial number of 5XD04298. Sales engineer 108-4 may submit this PBO file to configuration management architecture 105. Upon receiving the request to load configuration data for the backhoe loader of serial number 5XD04298 from factory engineer 108-5, configuration management system 190 may search the ITC relationships in database 180 by checking the qualifying conditions in the ITC relationships. For example, configuration management system 190 may check the PBO file shown in FIG. 6B against the ITC relationship shown in FIG. 4B. Configuration management system 190 may compare qualifying conditions 480 against the data submitted in the PBO file. Because the data in the submitted PBO file of FIG. 6B satisfies the qualifying conditions 480 (i.e., ordered item=21636 and sales model=3A), configuration management system 190 may provide configuration data 490 to factory operator 108-5 for the ordered product in a configuration data file. Other associated configuration data (product build variables 680) and their values defined in the PBO file are also added to the configuration data file.

When factory operator 108-5 is ready to load configuration data into an ECM for part 120050 (i.e. the backhoe loader transmission control) of the ordered backhoe loader, factory operator 108-5 may use the configuration management system 190 to load the product operational control files, such as flash file 120050.FLS, and configuration data files, such as the configuration data file generated in step 620 (step 630). Configuration management system 190 may also provide the orderable items related to the PBO and their corresponding ITCs to be loaded/processed.

Referring back to the example shown in FIG. 4B and FIG. 6B, factory operator 108-5 may use configuration management system 190 to load 120050.FLS, configuration data 490 and the product build variable element 680 in the PBO file of FIG. 6B (fan speed) into the model 3A transmission ECM for the ordered backhoe loader of serial number 5XD04298. When the transmission ECM is in operation, flash file 120050.FLS may be used to retrieve configuration data (for example, configuration data 490 and product build variable element 680) loaded into the ECM to perform functions of the transmission ECM.

### INDUSTRIAL APPLICABILITY

Configuration management systems and methods consistent with the disclosed embodiments provide fully integrated configuration management in a product's design, testing, manufacturing, and delivery processes. The disclosed embodiments enable a product's configuration to be customized, and at the same time, ensure the integrity of the custom configuration requested by a customer.

The disclosed embodiments are applicable to manage configuration data for control modules of many types of products including software or hardware based products. For example, an enterprise software application, such as an ERP system, may require complex application configurations in different implementations. The disclosed embodiments allow the coordination of the parties in the environment of configuration management. Configuration management environment members such as design engineers and sales engineers can use the disclosed embodiments to implement highly custom configured enterprise software applications to their customers.

It will be apparent to those skilled in the art that various modifications and variations can be made in the disclosed embodiments without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A configuration management system, comprising:
a memory, and
a processor configured to:
store a product operational control file for controlling a product based on configuration data,
define a plurality of orderable items,
define relationships between the plurality of orderable items and the configuration data,
receive an order for the product including a configuration requirement, the configuration requirement including one or more of the plurality of orderable items, and
load the product operational control file and the configuration data onto the ordered product according to the defined relationships between the orderable items and the configuration data, and the configuration requirement of the ordered product.

2. The system of claim 1, wherein the processor is further configured to:
generate a configuration data file definition file describing valid settings for a configuration parameter.

3. The system of claim 2, wherein the processor is further configured to:
verify the product operational control file and the configuration data loaded onto the ordered product by comparing the configuration data to the order for the product.

4. The system of claim 2, wherein the processor is further configured to:
verify the relationships between the one or more of the plurality of orderable items and the configuration data based on the configuration data file definition file.

5. The system of claim 2, wherein a relationship between one of the plurality of the orderable items and the configuration data includes a qualification condition part and a configuration data part.

6. The system of claim 5, wherein the processor is further configured to:
verify whether data from the order for the product satisfy the qualification condition part, and
provide the configuration data part if the data from the order for the product satisfy the qualification condition part.

7. The system of claim 1, wherein the processor is further configured to:
define the sequence that the one or more of the plurality of orderable items is to be loaded onto the ordered product.

8. A method for configuration management, comprising:
performing a configuration process through the interaction of members of a configuration management environment, the configuration process used to manufacture a product designed to host an electronic control module (ECM) for controlling a component of the product, the configuration process including:
storing a product operational control file for controlling a product based on configuration data;
defining a plurality of orderable items;
defining relationships between the plurality of orderable items and the configuration data;
receiving an order for the product including a configuration requirement, the configuration requirement including one or more of the plurality of orderable items; and
loading the product operational control file and the configuration data onto the ordered product according to the defined relationships between the orderable items and the configuration data, and the configuration requirement of the ordered product.

9. The method of claim 8, wherein the configuration process further includes:
generating a configuration data file definition file describing valid settings for a configuration parameter.

10. The method of claim 9, wherein the configuration process further includes:
verifying the product operational control file and the configuration data loaded onto the ordered product by comparing the configuration data to the order for the product.

11. The method of claim 9, wherein the configuration process further includes:
verifying the relationships between the one or more of the plurality of orderable items and the configuration data based on the configuration data file definition file.

12. The method of claim 9, wherein a relationship between one of the plurality of the orderable items and the configuration data includes a qualification condition part and a configuration data part.

13. The method of claim 12, wherein the configuration process further includes:
verifying whether data from the order for the product satisfy the qualification condition part; and
providing the configuration data part if the data from the order for the product satisfy the qualification condition part.

14. The method of claim 8, wherein the configuration process further includes:
defining the sequence that the one or more of the plurality of orderable items is to be loaded onto the ordered product.

15. A method for configuration management in a configuration management environment including members, the method comprising:
storing a product operational control file for controlling a product based on configuration data;
defining a plurality of orderable items;
defining relationships between the plurality of orderable items and the configuration data;
receiving an order for the product including a configuration requirement, the configuration requirement including one or more of the plurality of orderable items; and
loading the product operational control file and the configuration data onto the ordered product according to the defined relationships between the orderable items and the configuration data, and the configuration requirement of the ordered product.

16. The method of claim 15, further including:
generating a configuration data file definition file describing valid settings for a configuration parameter.

17. The method of claim 16, further including:
verifying the product operational control file and the configuration data loaded onto the ordered product by comparing the configuration data to the order for the product.

18. The method of claim 16, further including:
verifying the relationships between the one or more of the plurality of orderable items and the configuration data based on the configuration data file definition file.

19. The method of claim 16, wherein a relationship between one of the plurality of the orderable items and the configuration data includes a qualification condition part and a configuration data part, and the method further includes:
verifying whether data from the order for the product satisfy the qualification condition part; and
providing the configuration data part if the data from the order for the product satisfy the qualification condition part.

20. The method of claim 15, further including:
defining the sequence that the one or more of the plurality of orderable items is to be loaded onto the ordered product.
